(19) United States
(12) Patent Application Publication
(10) Pub. No.: US 2026/0359691 A1
(43) Pub. Date: Nov. 12, 2026

(54) PERFORMING QUANTUM CIRCUIT COMPILATION USING SPANNING TREES TO IDENTIFY MEANINGFUL BOUNDS FOR AN ARBITRARY QUANTUM ARCHITECTURE

(71) Applicant: International Business Machines Corporation, Armonk, NY (US)

(72) Inventors: Simon Martiel, Bordeaux (FR); Tristan Cam, Bordeaux (FR)

(21) Appl. No.: 19/204,548

(22) Filed: May 11, 2025

(51) Int. Cl. G06N 10/20; G06N 10/40

(52) U.S. Cl. CPC G06N 10/20; G06N 10/40

(57) ABSTRACT

A method, system, and computer program product for performing quantum circuit compilation. A spanning tree of a graph of a target quantum architecture is identified. A spanning tree refers to a subgraph, such as the subgraph of the connected graph of the target quantum architecture, that is a tree without any cycles and includes all the vertices of the original graph of the target quantum architecture. The vertices of a Hamiltonian path found in the spanning tree are then labeled. The Hamiltonian path may then be identified in the graph of the target quantum architecture based on the labeled Hamiltonian path found in the spanning tree. The quantum circuit is then transpiled by arranging an order of qubits of the quantum circuit based on the order of the qubits from the Hamiltonian path. Such a rearrangement of the qubits optimizes the quantum circuit for execution on the target quantum architecture.

### TECHNICAL FIELD

The present disclosure relates generally to quantum circuit compilation, and more particularly to performing quantum circuit compilation using spanning trees to identify meaningful bounds for an arbitrary quantum architecture.

### BACKGROUND

Quantum circuit compilation translates high-level quantum algorithms into a form executable on a specific quantum device, optimizing for factors, such as gate count, runtime, and fidelity, while respecting the quantum device's constraints. For instance, quantum circuit compilation involves taking a high-level description of a quantum algorithm (a quantum circuit) and converting it into a form that can be executed on a specific quantum device. Such a process includes optimizations to reduce the number of gates, minimize circuit depth, and manage available resources.

Transpilation is a specialized form of compilation that specifically focuses on transforming a quantum circuit to match the constraints and characteristics of a particular target quantum device. It involves decomposing complex gates, such as breaking down complex quantum gates into simpler, native gates supported by the target hardware. Furthermore, transpilation involves optimizing for hardware connectivity, such as rearranging qubits to match the connectivity of the target quantum device, potentially using SWAP gates to overcome limited connectivity. Additionally, transpilation involves optimizing for noise. For example, the impact of noise on the circuit's execution is minimized by optimizing gate placement and timing. Furthermore, transpilation involves Instruction Set Architecture (ISA) compliance, which ensures that the transpiled circuit only uses instructions that are supported by the target quantum device, such as the hardware's available basis gates, measurements, resets, and control flow operations.

Transpilation is a crucial step in the broader process of quantum circuit compilation as it ensures that the final quantum circuit is executable on the target quantum hardware and optimized for its specific characteristics.

In transpilation, a coupling map, which represents the connectivity of qubits on a quantum device, is crucial for transpilation as it informs the routing and layout stages that determine how virtual qubits are mapped to physical qubits and how gates are implemented.

Unfortunately, coupling maps may limit qubit interactions to a strict subset of interactions which negatively affects quantum circuit mapping, which is a key part of transpilation. Quantum circuit mapping is the process of transforming a logical quantum circuit into a physical circuit that can be executed on the target quantum processor. When the coupling map is limited, the mapping process becomes more complex, such as requiring the use of more SWAP gates or other methods to achieve the desired interactions between qubits. As a result, the gate overhead increases which increases the quantum circuit's depth (or execution time).

Furthermore, with such limited coupling maps, it becomes difficult to transpile a quantum circuit from one type of quantum architecture (a quantum architecture is a fundamental structure and organization of a quantum computer), such as the linear nearest neighbor architecture, to an arbitrary quantum architecture due to the difficultly in knowing the precise bounds (limits) on the number of gates and the depth of the quantum circuit to be compiled.

### SUMMARY

In one embodiment of the present disclosure, a method for performing quantum circuit compilation comprises identifying a spanning tree of a graph of a quantum architecture, where the spanning tree is a subgraph of the graph of the quantum architecture that connects all vertices of the graph of the quantum architecture without any cycles, where the vertices of the spanning tree represent qubits, and where edges of the spanning tree represent entanglement or interactions between the qubits. The method further comprises labeling vertices of a Hamiltonian path found in the spanning tree. The method additionally comprises identifying a Hamiltonian path in the graph of the quantum architecture based on the labeled Hamiltonian path found in the spanning tree. Furthermore, the method comprises transpiling a quantum circuit by arranging an order of qubits of the quantum circuit based on an order of qubits from the Hamiltonian path identified in the graph of the quantum architecture.

Furthermore, in one embodiment of the present disclosure, the labeling depends on a quantum architecture to emulate.

Additionally, in one embodiment of the present disclosure, the graph of the quantum architecture corresponds to a d-dimensional grid, where the d is a positive integer number, and where the emulated quantum architecture corresponds to a cartesian product of the d number of trees.

Furthermore, in one embodiment of the present disclosure, the graph of the quantum architecture corresponds to a graph that is 2-connected, where the Hamiltonian path is identified in a square of the spanning tree.

Additionally, in one embodiment of the present disclosure, the graph of the quantum architecture corresponds to a graph that is 3-connected, where the Hamiltonian path is identified in a cube of the spanning tree.

Furthermore, in one embodiment of the present disclosure, the transpilation involves implementing a gate between two qubits lying at a distance of at most two or three in the graph of the quantum architecture.

Additionally, in one embodiment of the present disclosure, the gate is implemented by synthesizing a subcircuit implementing the gate on a path of a length of the at most two or three or by inserting SWAP gates.

Other forms of the embodiments of the method described above are in a system and in a computer program product.

Accordingly, embodiments of the present disclosure perform quantum circuit compilation by transpiling a quantum circuit from one type of quantum architecture to an arbitrary quantum architecture while preserving the depth of the circuit up to a multiplicative constant.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for performing quantum circuit compilation by transpiling a quantum circuit from one type of quantum architecture to an arbitrary quantum architecture in accordance with an embodiment of the present disclosure;

FIGS. 3A-3B illustrate identifying a Hamiltonian path and identifying a non-Hamiltonian path, respectively, in accordance with an embodiment of the present disclosure;

FIG. 4A illustrates a graph of a quantum architecture that does not contain a Hamiltonian path in accordance with an embodiment of the present disclosure;

FIG. 4B illustrates a spanning tree of a maximal degree of 3 in accordance with an embodiment of the present disclosure;

FIG. 5 illustrates labeling vertices of a Hamiltonian path in a leapfrogging manner in accordance with an embodiment of the present disclosure;

FIG. 6A illustrates an operator, O, between qubits q₀ and q₁ in accordance with an embodiment of the present disclosure;

FIG. 6B illustrates circuit C rewritten as C′ as a box by inserting SWAP gates in accordance with an embodiment of the present disclosure;

FIG. 6C illustrates circuit C rewritten as C′ as a box by synthesizing a new subcircuit in accordance with an embodiment of the present disclosure;

FIG. 7A illustrates a cartesian product of two trees with a distance-2 labeling in accordance with an embodiment of the present disclosure;

FIG. 7B illustrates a resulting graph for performing the cartesian product of two trees with a distance-2 labeling shown in FIG. 7A in accordance with an embodiment of the present disclosure;

FIG. 8 illustrates an embodiment of the present disclosure of the hardware configuration of the classical computer which is representative of a hardware environment for practicing the present disclosure; and

FIG. 9 is a flowchart of a method for performing quantum circuit compilation by transpiling a quantum circuit from one type of quantum architecture to an arbitrary quantum architecture while preserving the depth of the circuit up to a multiplicative constant in accordance with an embodiment of the present disclosure.

### DETAILED DESCRIPTION

In one embodiment of the present disclosure, a method for performing quantum circuit compilation comprises identifying a spanning tree of a graph of a quantum architecture, where the spanning tree is a subgraph of the graph of the quantum architecture that connects all vertices of the graph of the quantum architecture without any cycles, where the vertices of the spanning tree represent qubits, and where edges of the spanning tree represent entanglement or interactions between the qubits. The method further comprises labeling vertices of a Hamiltonian path found in the spanning tree. The method additionally comprises identifying a Hamiltonian path in the graph of the quantum architecture based on the labeled Hamiltonian path found in the spanning tree. Furthermore, the method comprises transpiling a quantum circuit by arranging an order of qubits of the quantum circuit based on an order of qubits from the Hamiltonian path identified in the graph of the quantum architecture.

In this manner, there is a constructive method for transpiling quantum circuits from one type of quantum architecture to an arbitrary quantum architecture while preserving the depth of the circuit up to a multiplicative constant.

Furthermore, in one embodiment of the present disclosure, the labeling depends on a quantum architecture to emulate.

In this manner, a Hamiltonian path can be found in the emulated quantum architecture based on the Hamiltonian path found in the spanning tree.

Additionally, in one embodiment of the present disclosure, the graph of the quantum architecture corresponds to a d-dimensional grid, where the d is a positive integer number, and where the emulated quantum architecture corresponds to a cartesian product of the d number of trees.

In this manner, a quantum circuit can be transpiled from a square grid to an arbitrary quantum architecture.

Furthermore, in one embodiment of the present disclosure, the graph of the quantum architecture corresponds to a graph that is 2-connected, where the Hamiltonian path is identified in a square of the spanning tree.

In this manner, 2-connectivity provides fault tolerance while the Hamiltonian path in the square of the spanning tree enables efficient routing and execution of quantum algorithms.

Additionally, in one embodiment of the present disclosure, the graph of the quantum architecture corresponds to a graph that is 3-connected, where the Hamiltonian path is identified in a cube of the spanning tree.

In this manner, 3-connectivity provides fault tolerance while the Hamiltonian path in the cube of the spanning tree enables efficient routing and execution of quantum algorithms.

Furthermore, in one embodiment of the present disclosure, the transpilation involves implementing a gate between two qubits lying at a distance of at most two or three in the graph of the quantum architecture.

In this manner, the need for SWAP operations, which are costly and prone to errors, is significantly reduced thereby minimizing the number of gates and the overall execution time of the quantum circuit.

Additionally, in one embodiment of the present disclosure, the gate is implemented by synthesizing a subcircuit implementing the gate on a path of a length of the at most two or three or by inserting SWAP gates.

In this manner, the overall depth and complexity of the quantum circuit is reduced by minimizing the use of SWAP gates and finding efficient paths thereby leading to faster and more reliable execution.

Other forms of the embodiments of the method described above are in a system and in a computer program product.

As stated above, transpilation is a specialized form of compilation that specifically focuses on transforming a quantum circuit to match the constraints and characteristics of a particular target quantum device. It involves decomposing complex gates, such as breaking down complex quantum gates into simpler, native gates supported by the target hardware. Furthermore, transpilation involves optimizing for hardware connectivity, such as rearranging qubits to match the connectivity of the target quantum device, potentially using SWAP gates to overcome limited connectivity. Additionally, transpilation involves optimizing for noise. For example, the impact of noise on the circuit's execution is minimized by optimizing gate placement and timing. Furthermore, transpilation involves Instruction Set Architecture (ISA) compliance, which ensures that the transpiled circuit only uses instructions that are supported by the target quantum device, such as the hardware's available basis gates, measurements, resets, and control flow operations.

Transpilation is a crucial step in the broader process of quantum circuit compilation as it ensures that the final quantum circuit is executable on the target quantum hardware and optimized for its specific characteristics.

In transpilation, a coupling map, which represents the connectivity of qubits on a quantum device, is crucial for transpilation as it informs the routing and layout stages that determine how virtual qubits are mapped to physical qubits and how gates are implemented.

Unfortunately, coupling maps may limit qubit interactions to a strict subset of interactions which negatively affects quantum circuit mapping, which is a key part of transpilation. Quantum circuit mapping is the process of transforming a logical quantum circuit into a physical circuit that can be executed on the target quantum processor. When the coupling map is limited, the mapping process becomes more complex, such as requiring the use of more SWAP gates or other methods to achieve the desired interactions between qubits. As a result, the gate overhead increases which increases the quantum circuit's depth (or execution time).

Furthermore, with such limited coupling maps, it becomes difficult to transpile a quantum circuit from one type of quantum architecture (a quantum architecture is a fundamental structure and organization of a quantum computer), such as the linear nearest neighbor architecture, to an arbitrary quantum architecture due to the difficultly in knowing the precise bounds (limits) on the number of gates and the depth of the quantum circuit to be compiled.

The embodiments of the present disclosure provide the means for performing quantum circuit compilation by adapting any quantum circuit that is compatible with a line or a square grid or a grid of higher dimension to an arbitrary quantum architecture by identifying meaningful bounds (e.g., bounds on the number of gates and the depth of the quantum circuit to be compiled) for such an arbitrary quantum architecture. Such a constructed quantum circuit is inflated by a factor that depends on a fundamental property of the arbitrary quantum architecture. For example, using the principles of the present disclosure, a quantum circuit transpiled for a d-dimensional grid can be implemented efficiently on a cartesian product of d trees, where d is a positive integer number.

In one embodiment, such a quantum circuit compilation is performed by identifying a spanning tree of a graph of a target quantum architecture. A spanning tree, as used herein, refers to a subgraph, such as the subgraph of the connected graph of the target quantum architecture, that is a tree without any cycles (closed loops) and includes all the vertices (nodes) of the original graph of the target quantum architecture. The target quantum architecture, as used herein, refers to the specific physical quantum structure and organization or type of qubits that a quantum algorithm is designed to run on. The vertices of a Hamiltonian path found in the spanning tree are then labeled. A Hamiltonian path, as used herein, is a path in a graph that visits every vertex exactly once. In one embodiment, the labeling of the vertices involves assigning integers to each vertex along the Hamiltonian path, which enables the following of the sequence of the vertices in the Hamiltonian path. As a result, such labeling represents the order of traversal and helps distinguish the Hamiltonian path from other, non-Hamiltonian paths by explicitly showing the order of vertex visitation. The Hamiltonian path may then be identified in the graph of the target quantum architecture based on the labeled Hamiltonian path found in the spanning tree. That is, by finding a Hamiltonian path in a spanning tree, which is a simpler graph structure, such information is leveraged to identify a corresponding Hamiltonian path in a more complex graph representing the target quantum architecture. The quantum circuit is then transpiled by arranging an order of qubits of the quantum circuit based on the order of the qubits from the Hamiltonian path. Such a rearrangement of the qubits optimizes the quantum circuit for execution on the target quantum architecture, especially when the qubits have limited connectivity. In this manner, quantum circuits from a linear nearest neighbor quantum architecture, a square grid quantum architecture or a grid of higher dimension can be transpiled to an arbitrary quantum architecture while preserving the depth of the circuit up to a multiplicative constant. These and other features will be discussed in further detail below.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

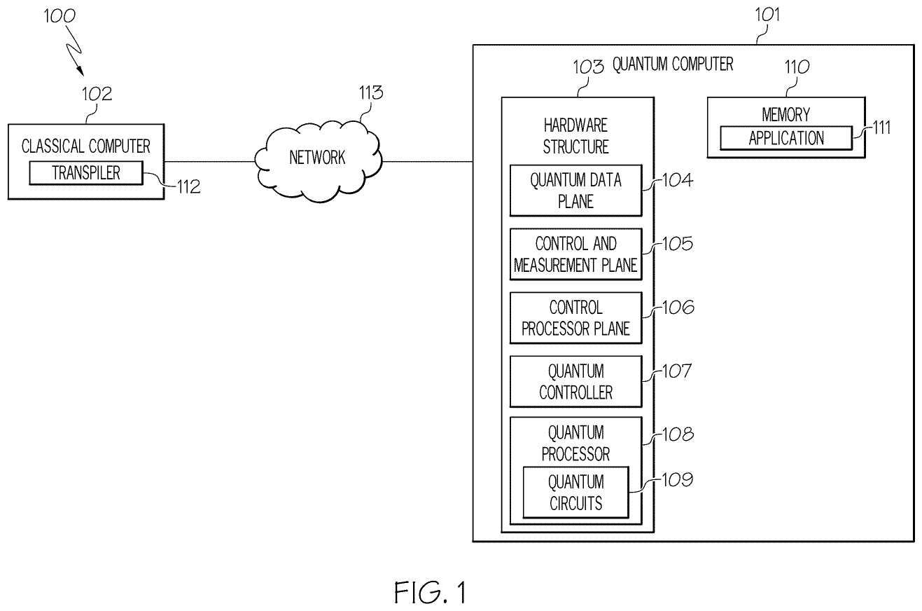

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to perform quantum circuit compilation by transpiling a quantum circuit from one type of quantum architecture to an arbitrary quantum architecture while preserving the depth of the circuit up to a multiplicative constant.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits'state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, which corresponds to a rotation of the qubit state around the X-axis by the given angle theta θ on the Bloch sphere), RY (also identified as Ry) (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

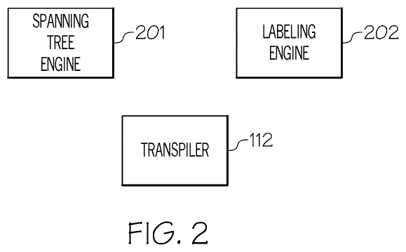

In one embodiment, memory 110 stores an application 111 that may be configured to implement one or more of the methods described herein in accordance with one or more embodiments. For example, application 111 may implement a program for performing quantum circuit compilation by transpiling a quantum circuit from one type of quantum architecture to an arbitrary quantum architecture while preserving the depth of the circuit up to a multiplicative constant as discussed further below in connection with FIGS. 2, 3A-3B, 4A-4B, 5, 6A-6C, 7A-7B and 9. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit. transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features) * (number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network, and various combinations thereof, etc. Other networks, whose descriptions are omitted here for brevity, may also be used in conjunction with system 100 of FIG. 1 without departing from the scope of the present disclosure.

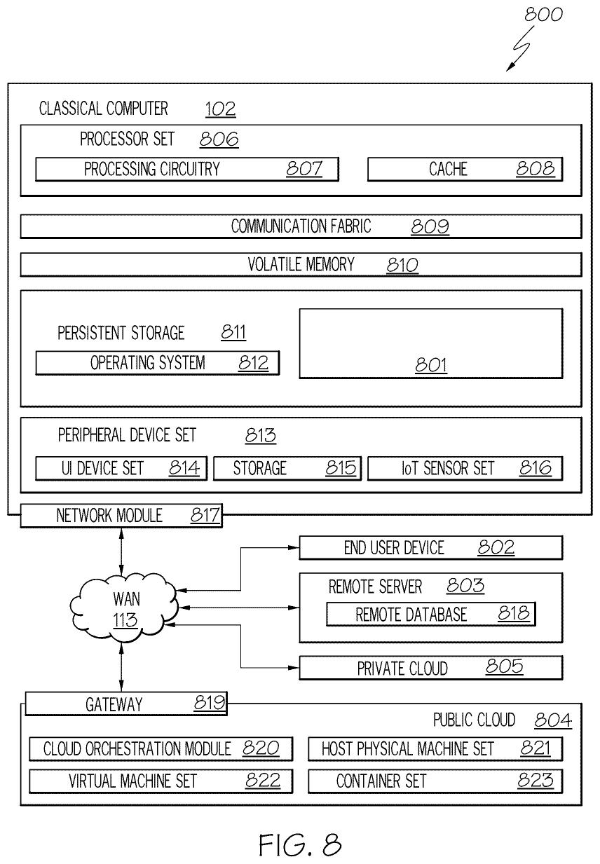

Furthermore, classical computer 102 is configured to perform quantum circuit compilation by transpiling a quantum circuit from one type of quantum architecture to an arbitrary quantum architecture while preserving the depth of the circuit up to a multiplicative constant as discussed further below in connection with FIGS. 2, 3A-3B, 4A-4B, 5, 6A-6C, 7A-7B and 9. A description of the software components of classical computer 102 is provided below in connection with FIG. 2 and a description of the hardware configuration of classical computer 102 is provided further below in connection with FIG. 8.

System 100 is not to be limited in scope to any one particular network architecture. System 100 may include any number of quantum computers 101, classical computers 102, and networks 113.

A discussion regarding the software components used by classical computer 102 for performing quantum circuit compilation by transpiling a quantum circuit from one type of quantum architecture to an arbitrary quantum architecture while preserving the depth of the circuit up to a multiplicative constant is provided below in connection with FIG. 2.

FIG. 2 is a diagram of the software components of classical computer 102 (FIG. 1) for performing quantum circuit compilation by transpiling a quantum circuit from one type of quantum architecture to an arbitrary quantum architecture in accordance with an embodiment of the present disclosure.

Referring to FIG. 2, in conjunction with FIG. 1, classical computer 102 includes a spanning tree engine 201 configured to identify a spanning tree of a graph of a target quantum architecture. A spanning tree, as used herein, refers to a subgraph, such as the subgraph of the connected graph of the target quantum architecture, that is a tree without any cycles (closed loops) and includes all the vertices (nodes) of the original graph of the target quantum architecture. The target quantum architecture, as used herein, refers to the specific physical quantum structure and organization or type of qubits that a quantum algorithm is designed to run on.

In one embodiment, the vertices of the graph of the target quantum architecture represent qubits and the edges of the graph of the target quantum architecture represent entanglement or interactions between the qubits.

In one embodiment, spanning tree engine 201 identifies a spanning tree of a quantum architecture graph by finding a minimal set of edges that connect all qubits (nodes) in the graph without creating cycles. In one embodiment, spanning tree engine 201 utilizes various algorithms, such as Prim's or Kruskal's, to find a minimum spanning tree, which is a spanning tree with the least total edge weight. That is, a minimum spanning tree, as used herein, is a spanning tree where the sum of the edge weights is minimized.

As discussed above, spanning tree engine 201 may utilize Prim's algorithm to identify a spanning tree of a quantum architecture graph, such as a minimum spanning tree. In one embodiment, the Prim's algorithm starts with a single vertex and iteratively adds the least-weighted edge that connects a vertex in the tree to a vertex outside the tree until all vertices are included.

As further discussed above, spanning tree engine 201 may utilize Kruskal's algorithm to identify a spanning tree of a quantum architecture graph, such as a minimum spanning tree. In one embodiment, the Kruskal's algorithm sorts edges by weight and adds them to the tree one by one, ensuring that no cycles are created.

Furthermore, in one embodiment, spanning tree engine 201 uses depth-first search (DFS) or breadth-first search (BFS) to explore the graph of the target quantum architecture and construct a spanning tree by connecting vertices without creating cycles. In one embodiment, the DFS and BFS algorithms traverse the graph of the target quantum architecture by exploring neighbors recursively or iteratively, respectively. In one embodiment, DFS uses a stack while BFS uses a queue. Both algorithms (DFS and BFS) are used to construct a spanning tree by keeping track of the visited vertices and their connections.

Classical computer 102 further includes a labeling engine 202 configured to label the vertices of a Hamiltonian path found in the spanning tree. A Hamiltonian path, as used herein, is a path in a graph that visits every vertex exactly once.

In one embodiment, labeling engine 202 identifies a Hamiltonian path in the spanning tree. In one embodiment, labeling engine 202 starts at any vertex in the spanning tree and follows the edges in a way that visits each vertex only once. In order for such a path to be considered a Hamiltonian path, the path must cover all vertices of the spanning tree, including the starting vertex and the ending vertex. No edge or vertex can be repeated in the path. For example, if the spanning tree has 5 vertices (A, B, C, D, and E), and a Hamiltonian path exists, it could be a path, such as A->B->C->D->E.

Labeling engine 202 utilizes various software tools for identifying a Hamiltonian path in the spanning tree, including, but not limited to, OR-tools, CySpanningTree, etc.

In one embodiment, the labeling of the vertices involves assigning integers to each vertex along the Hamiltonian path, which enables the following of the sequence of the vertices in the Hamiltonian path. As a result, such labeling represents the order of traversal and helps distinguish the Hamiltonian path from other, non-Hamiltonian paths by explicitly showing the order of vertex visitation.

In one embodiment, labeling engine 202 assigns consecutive integers, starting with 1, to each vertex as it is visited in the Hamiltonian path thereby ensuring that each vertex is labeled only once reflecting the Hamiltonian path's property of visiting each vertex exactly once.

As discussed above, a Hamiltonian path is a path in a graph that visits every vertex exactly once. As a result, labeling engine 202 assigns consecutive numbers to the vertices in the order they appear in the path. For example, if spanning tree engine 201 identified a Hamiltonian path as A->B->C->D->E, then labeling engine 202 labels the vertices as follows: A: 1, B: 2, C: 3, D: 4, and E: 5. Such a labeling scheme ensures that each vertex is assigned a unique number, and the numbers reflect the order in which the vertices are visited in the Hamiltonian path.

Labeling engine 202 utilizes various software tools for labeling vertices of a Hamiltonian path found in the spanning tree, including, but not limited to, OR-tools, NetworkX, etc.

In one embodiment, labeling engine 202 identifies a Hamiltonian path in the graph of the target quantum architecture based on the labeled Hamiltonian path found in the spanning tree.

In one embodiment, the labeled Hamiltonian path in the spanning tree provides a sequence of vertices to follow. Such a sequence of vertices is traced in the graph of the target quantum architecture to find the corresponding Hamiltonian path. For example, suppose that labeling engine 202 identifies a Hamiltonian path in the spanning tree and labels the vertices of such a Hamiltonian path in the spanning tree as discussed above. For instance, labeling engine 202 may label the sequence of Qubit A->Qubit B->Qubit C->Qubit D. Labeling engine 202 then traces the same sequence of qubits (A->B->C->D) on the graph of the target quantum architecture by following the connections that exist in the graph of the target quantum architecture between those qubits thereby identifying the Hamiltonian path in the graph of the target quantum architecture.

Labeling engine 202 utilizes various software tools for identifying a Hamiltonian path in the graph of the target quantum architecture as discussed above, including, but not limited to, OR-tools, CySpanningTree, etc.

In one embodiment, the graph labeling strategy of labeling engine 202 enables the rerouting of the qubits in the graph (H) of the target quantum architecture. In one embodiment, such labeling depends on the quantum architecture (G) to emulate. In one embodiment, the graph of the target quantum architecture corresponds to a d-dimensional grid, where d is a positive integer number, and the emulated quantum architecture corresponds to a cartesian product of the d number of trees.

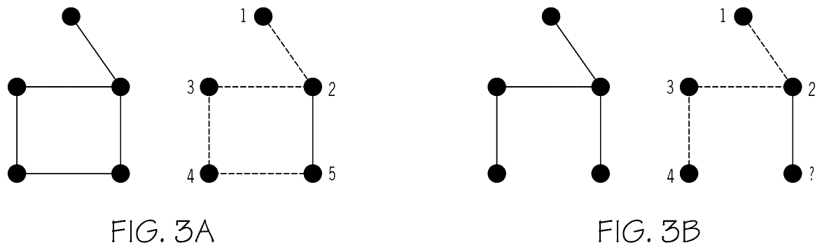

For instance, suppose that an n-qubit hardware is represented by graph H and provided a quantum circuit C written for a particular quantum architecture (e.g., linear nearest neighbor quantum architecture). In one embodiment, labeling engine 202 assigns each vertex from graph H an integer label such that the order of the labeled vertices provides the path on n vertices that is the linear nearest neighbor quantum architecture. The result is identifying a Hamiltonian path on H. However, not all graphs have a Hamiltonian path as illustrated in FIGS. 3A-3B.

FIGS. 3A-3B illustrate identifying a Hamiltonian path and identifying a non-Hamiltonian path, respectively, in accordance with an embodiment of the present disclosure.

As shown in FIG. 3A, the labeling of the vertices from 1 to 5 illustrates a Hamiltonian path; however, as shown in FIG. 3B, the labeling of the vertices does not result in labeling each of the vertices thereby identifying a non-Hamiltonian graph.

As a result, it is noted that the cube H³, G³, of any connected graph H, G, respectively, has a Hamiltonian path. H^{k}, G^{k} of an undirected graph H, G, respectively, is another graph that has the same set of vertices, but in which two vertices are adjacent when their distance in H, G, respectively, is at most k. H², G², as used herein, is called the square of H, G, respectively. H³, G³, as used herein, is called the cube of H, G, respectively.

In one embodiment, the graph of the target quantum architecture corresponds to a graph that is 2-connected, where the Hamiltonian path is identified by labeling engine 202 in a square of the spanning tree. In another embodiment, the graph of the target quantum architecture corresponds to a graph that is 3-connected, where the Hamiltonian path is identified by labeling engine 202 in a cube of the spanning tree.

As a result, the labeling of H³ results in having each pair of consecutively labeled vertices in H³ at a distance of exactly one while having the vertices of H³ being exactly equal to those of H. Hence, the labeling applied to the vertices of H is such that each pair of consecutively labeled vertices in H is at a distance of at most 3 (distance-3 labeling of H).

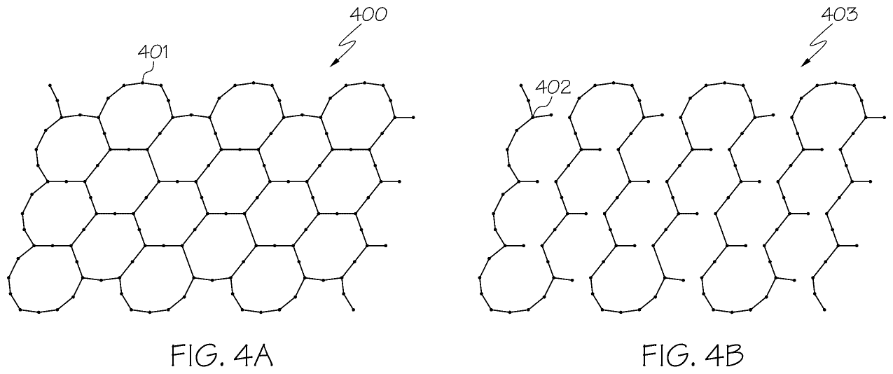

Thus, in one embodiment, spanning tree engine 201 identifies a spanning tree T of the hardware graph H (preferably of small maximal degree) and labeling engine 202 labels a Hamiltonian path in H³ and applies this label back to H as illustrated in FIGS. 4A-4B.

FIG. 4A illustrates a graph of a quantum architecture that does not contain a Hamiltonian path in accordance with an embodiment of the present disclosure. FIG. 4B illustrates a spanning tree of a maximal degree of 3 in accordance with an embodiment of the present disclosure.

As illustrated in FIG. 4A, there is no path in graph 400 that visits every vertex 401 exactly once. However, as illustrated in FIG. 4B, each pair of consecutively labeled vertices 402 in a Hamiltonian path of graph 403 of a spanning tree of graph 400 is at most a distance of 3.

Furthermore, in one embodiment, when H is 2-connected, labeling engine 202 labels the vertices of the Hamiltonian paths in H² (a graph G is 2-connected if for any vertex v of G, G-v is connected).

In one embodiment, the square of a tree, such as the horsetail tree, has a Hamiltonian path. As a result, identifying such a spanning tree on the graph of the target quantum architecture yields a better multiplicative constant on the depth of the transpiled quantum circuit compared to that of the original quantum circuit.

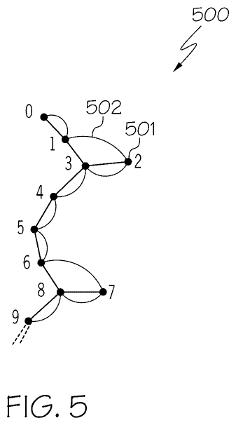

In one embodiment, the labels provided by labeling engine 202 correspond to leapfrogging from one qubit to the next, its neighbor or near-neighbor as illustrated in FIG. 5.

FIG. 5 illustrates labeling vertices of a Hamiltonian path in a leapfrogging manner in accordance with an embodiment of the present disclosure.

Referring to FIG. 5, the labeling of vertices 501 in a Hamiltonian path 502 (identified by consecutive integer numbers from 0 to 9) of spanning tree 500 is in a leapfrogging manner with a distance-2 labeling (i.e., each pair of consecutively labeled vertices 501 in Hamiltonian path 502 of spanning tree 500 is at most a distance of 2). Such an identified Hamiltonian path 502 is then used to identify a Hamiltonian path in the graph of the target quantum architecture.

Furthermore, classical computer 102 includes transpiler 112 configured to transpile the quantum circuit by arranging an order of the qubits of the quantum circuit based on an order of the qubits from the Hamiltonian path. That is, transpiler 112 rearranges the order of the qubits of the quantum circuit based on the Hamiltonian path found in the graph of the target quantum architecture in order to optimize the quantum circuit's execution on the target quantum device, where the qubits are physically arranged in a particular topology. By rearranging the order of the qubits of the quantum circuit based on the Hamiltonian path found in the graph of the target quantum architecture, a minimal number of SWAP gates may be utilized to map the quantum circuit to the physical device thereby efficiently executing the quantum circuit on the target device. That is, by transpilating the quantum circuit in such a manner, the number of operations (e.g., SWAP gates) is minimized and the circuit's depth (the number of time steps required to execute the quantum circuit) is reduced.

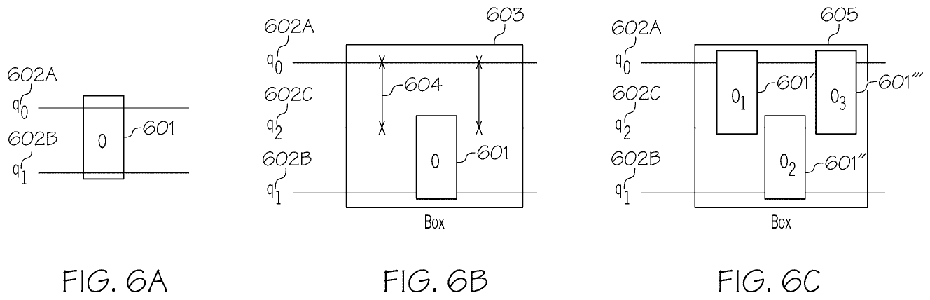

In one embodiment, labeling engine 202 performs distance-based labeling of the qubits (vertices of H) so as to provide a direct recipe to group neighboring qubits “on the fly” when parsing the circuit C (originally on hardware G) and rewrite a new circuit C′ with only linearly increased depth. The only places where C′ differs from C is when H differs from G. In such a case, in one embodiment, transpiler 112 implements a gate between two qubits lying at a distance of at most 2 or 3 in H. In one embodiment, transpiler 112 implements the gate by synthesizing a subcircuit (referred to herein as a “box”) implementing the gate on a path of a length of at most 2 or 3 or by inserting SWAP gates (two-qubit operation that exchanges the quantum states of two qubits) as illustrated in FIGS. 6A-6C.

FIG. 6A illustrates an operator 601, O, between qubits q₀ 602A and q₁ 602B in accordance with an embodiment of the present disclosure. That is, FIG. 6A illustrates operator 601, O, acting on both qubits q₀ 602A and q₁ 602B. Operator 601, as used herein, is a mathematical transformation that acts on the quantum state of qubits. Hence, in one embodiment, operator 601 (e.g., CNOT gate) influences the state of both qubits simultaneously. For example, a CNOT gate acts between the two qubits 602A, 602B, flipping the state of the target qubit based on the state of the control qubit.

FIG. 6B illustrates circuit C rewritten as C′ as a box by inserting SWAP gates in accordance with an embodiment of the present disclosure.

Referring to FIG. 6B, circuit C shown in FIG. 6A is rewritten as C′ as a box 603 by inserting SWAP gates 604 which exchange the quantum states of two qubits, qubits q₀ 602A and q₂ 602C.

FIG. 6C illustrates circuit C rewritten as C′ as a box by synthesizing a new subcircuit in accordance with an embodiment of the present disclosure.

Referring to FIG. 6C, circuit C shown in FIG. 6A is rewritten as C′ as a box 605 by synthesizing a new subcircuit containing operators 601′ (identified as O₁), 601″ (identified as O₂), and 601′″ (identified as O₃), which cross over qubit q₂ 602C.

In one embodiment, two gates that could be executed in parallel on G yield two intersecting boxes, such as boxes 603, 605. Each box will intersect at most O(Δ) other boxes where Δ is the maximum degree of the spanning tree chosen to determine the labeling.

Consequently, it is possible to arrange boxes corresponding to a single layer of the original circuit in a subcircuit of depth at most O(Δ).

In one embodiment, the depth of the content of those boxes depends on the labeling scheme adopted. It is noted that a distance-2 labeling is better than a distance-3 labeling by a small multiplicative constant, but both yield a transpiled circuit of depth O(ΔD), where D is the depth of C.

In one embodiment, the strategy of the present disclosure may be utilized to transpile quantum circuits from a linear nearest neighbor architecture to an arbitrary architecture. Furthermore, the strategy of the present disclosure may be utilized to transpile quantum circuits from the square grid, where the square grid of size n×n is the cartesian product of two paths of size n. A square grid quantum architecture, as used herein, refers to a design where qubits are arranged in a two-dimensional square grid. Thus, when H can be expressed as the cartesian product of two trees T₁ and T₂, the same labeling scheme of the present disclosure can be applied individually on T₁ and T_{2,} which results in providing grid-like coordinates to the vertices of H.

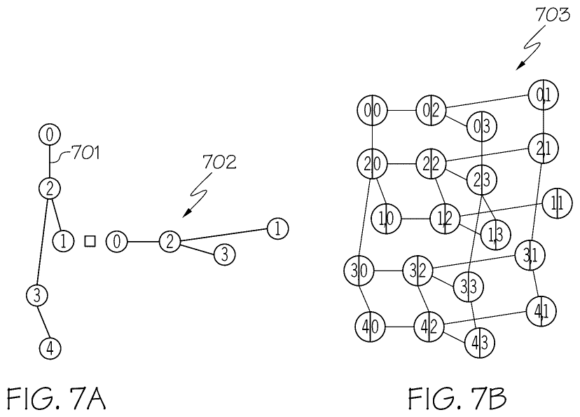

Such a construction can be generalized to a grid of dimension d with H=T₁□T2□ . . . □T_{d}, where □ is the cartesian product of graphs, assigning a size d coordinate vector to each vertex in H. If there is a decomposition of H in the cartesian product of connected graphs G₁□G2□ . . . □Gd of spanning trees T₁, T₂, T_{d}, then labeling engine 202 can label the trees for the same purpose as illustrated in FIGS. 7A-7B.

FIG. 7A illustrates a cartesian product of two trees 701, 702 with a distance-2 labeling in accordance with an embodiment of the present disclosure.

FIG. 7B illustrates a resulting graph 703 for performing the cartesian product of two trees 701, 702 with a distance-2 labeling shown in FIG. 7A in accordance with an embodiment of the present disclosure. As illustrated in FIG. 7B, such a resulting graph 703 includes grid-like coordinates.

In one embodiment, applying the strategy of the present disclosure inflates the original circuit depth by a factor of at most O(Δ₁+Δ₂+ . . . +Δ_{d}). Such a result can be generalized to any graph that is a cartesian product of trees of bounded degree.

Furthermore, the principles of the present disclosure enable generalizing known bounds on a line or grid to trees or a cartesian product of trees. For example, CNOT/CZ/Clifford circuits can be synthesized in depth O(n) on a line and thus in depth O(Δn) on a tree of max degree Δ. In another example, permutations can be implemented in depth O(n\hat{ }½) on a grid and thus in depth O(2Δn\hat{ }½) on a cartesian product of trees of max degrees Δ.

In this manner, quantum circuits from a linear nearest neighbor quantum architecture, a square grid quantum architecture or a grid of higher dimension can be transpiled to an arbitrary quantum architecture while preserving the depth of the circuit up to a multiplicative constant.

A further description of these and other functions is provided below in connection with the discussion of the method for performing quantum circuit compilation by transpiling a quantum circuit from one type of quantum architecture to an arbitrary quantum architecture while preserving the depth of the circuit up to a multiplicative constant.

Prior to the discussion of the method for performing quantum circuit compilation by transpiling a quantum circuit from one type of quantum architecture to an arbitrary quantum architecture while preserving the depth of the circuit up to a multiplicative constant, a description of the hardware configuration of classical computer 102 (FIG. 1) is provided below in connection with FIG. 8.

Referring now to FIG. 8, in conjunction with FIG. 1, FIG. 8 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code 801 involved in performing the inventive methods, such as performing quantum circuit compilation by transpiling a quantum circuit from one type of quantum architecture to an arbitrary quantum architecture while preserving the depth of the circuit up to a multiplicative constant. In addition to block 801, computing environment 800 includes, for example, classical computer 102, network 113, such as a wide area network (WAN), end user device (EUD) 802, remote server 803, public cloud 804, and private cloud 805. In this embodiment, classical computer 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically classical computer 102, to keep the presentation as simple as possible. Classical computer 102 may be located in a cloud, even though it is not shown in a cloud in FIG. 8. On the other hand, classical computer 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip.” In some computing environments, processor set 806 may be designed for working with qubits and performing quantum computing.

Computer readable program instructions are typically loaded onto classical computer 102 to cause a series of operational steps to be performed by processor set 806 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 810 is located in a single package and is internal to classical computer 102, but, alternatively or additionally, the volatile memory may be distributed over multiple packages and/or located externally with respect to classical computer 102.

Persistent Storage 811 is any form of non-volatile storage for computers that is now known or to be developed in the future. The non-volatility of this storage means that the stored data is maintained regardless of whether power is being supplied to classical computer 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows classical computer 102 to communicate with other computers through WAN 113. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to classical computer 102 from an external computer or external storage device through a network adapter card or network interface included in network module 817.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates classical computer 102), and may take any of the forms discussed above in connection with classical computer 102. EUD 802 typically receives helpful and useful data from the operations of classical computer 102. For example, in a hypothetical case where classical computer 102 is designed to provide a recommendation to an end user, this recommendation would typically be communicated from network module 817 of classical computer 102 through WAN 113 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to classical computer 102. Remote server 803 may be controlled and used by the same entity that operates classical computer 102. Remote server 803 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 2, 3A-3B, 4A-4B, 5, 6A-6C, and 7A-7B to perform quantum circuit compilation by transpiling a quantum circuit from one type of quantum architecture to an arbitrary quantum architecture while preserving the depth of the circuit up to a multiplicative constant. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for performing quantum circuit compilation by transpiling a quantum circuit from one type of quantum architecture to an arbitrary quantum architecture while preserving the depth of the circuit up to a multiplicative constant, may be embodied in an application-specific integrated circuit.

As stated above, transpilation is a specialized form of compilation that specifically focuses on transforming a quantum circuit to match the constraints and characteristics of a particular target quantum device. It involves decomposing complex gates, such as breaking down complex quantum gates into simpler, native gates supported by the target hardware. Furthermore, transpilation involves optimizing for hardware connectivity, such as rearranging qubits to match the connectivity of the target quantum device, potentially using SWAP gates to overcome limited connectivity. Additionally, transpilation involves optimizing for noise. For example, the impact of noise on the circuit's execution is minimized by optimizing gate placement and timing. Furthermore, transpilation involves Instruction Set Architecture (ISA) compliance, which ensures that the transpiled circuit only uses instructions that are supported by the target quantum device, such as the hardware's available basis gates, measurements, resets, and control flow operations. Transpilation is a crucial step in the broader process of quantum circuit compilation as it ensures that the final quantum circuit is executable on the target quantum hardware and optimized for its specific characteristics. In transpilation, a coupling map, which represents the connectivity of qubits on a quantum device, is crucial for transpilation as it informs the routing and layout stages that determine how virtual qubits are mapped to physical qubits and how gates are implemented. Unfortunately, coupling maps may limit qubit interactions to a strict subset of interactions which negatively affects quantum circuit mapping, which is a key part of transpilation. Quantum circuit mapping is the process of transforming a logical quantum circuit into a physical circuit that can be executed on the target quantum processor. When the coupling map is limited, the mapping process becomes more complex, such as requiring the use of more SWAP gates or other methods to achieve the desired interactions between qubits. As a result, the gate overhead increases which increases the quantum circuit's depth (or execution time). Furthermore, with such limited coupling maps, it becomes difficult to transpile a quantum circuit from one type of quantum architecture (a quantum architecture is a fundamental structure and organization of a quantum computer), such as the linear nearest neighbor architecture, to an arbitrary quantum architecture due to the difficultly in knowing the precise bounds (limits) on the number of gates and the depth of the quantum circuit to be compiled.

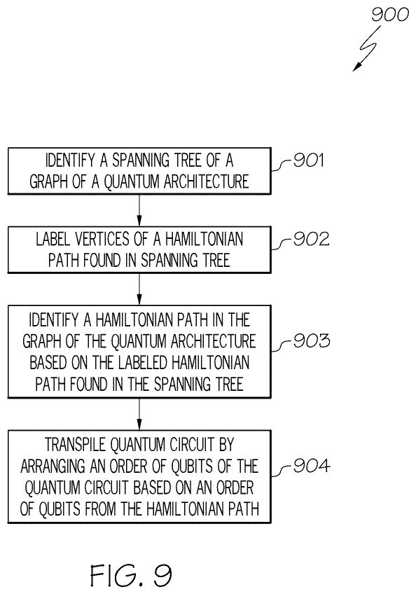

The embodiments of the present disclosure provide the means for performing quantum circuit compilation by adapting any quantum circuit that is compatible with a line or a square grid or a grid of higher dimension to an arbitrary quantum architecture by identifying meaningful bounds (e.g., bounds on the number of gates and the depth of the quantum circuit to be compiled) for such an arbitrary quantum architecture as discussed below in connection with FIG. 9.

FIG. 9 is a flowchart of a method 900 for performing quantum circuit compilation by transpiling a quantum circuit from one type of quantum architecture to an arbitrary quantum architecture while preserving the depth of the circuit up to a multiplicative constant in accordance with an embodiment of the present disclosure.

Referring to FIG. 9, in conjunction with FIGS. 1-2, 3A-3B, 4A-4B, 5, 6A-6C, 7A-7B and 8, in step 901, spanning tree engine 201 identifies a spanning tree of a graph of a target quantum architecture.

As discussed above, a spanning tree, as used herein, refers to a subgraph, such as the subgraph of the connected graph of the target quantum architecture, that is a tree without any cycles (closed loops) and includes all the vertices (nodes) of the original graph of the target quantum architecture. The target quantum architecture, as used herein, refers to the specific physical quantum structure and organization or type of qubits that a quantum algorithm is designed to run on.

In one embodiment, the vertices of the graph of the target quantum architecture represent qubits and the edges of the graph of the target quantum architecture represent entanglement or interactions between the qubits.

In one embodiment, spanning tree engine 201 identifies a spanning tree of a quantum architecture graph by finding a minimal set of edges that connect all qubits (nodes) in the graph without creating cycles. In one embodiment, spanning tree engine 201 utilizes various algorithms, such as Prim's or Kruskal's, to find a minimum spanning tree, which is a spanning tree with the least total edge weight. That is, a minimum spanning tree, as used herein, is a spanning tree where the sum of the edge weights is minimized.

As discussed above, spanning tree engine 201 may utilize Prim's algorithm to identify a spanning tree of a quantum architecture graph, such as a minimum spanning tree. In one embodiment, the Prim's algorithm starts with a single vertex and iteratively adds the least-weighted edge that connects a vertex in the tree to a vertex outside the tree until all vertices are included.

As further discussed above, spanning tree engine 201 may utilize Kruskal's algorithm to identify a spanning tree of a quantum architecture graph, such as a minimum spanning tree. In one embodiment, the Kruskal's algorithm sorts edges by weight and adds them to the tree one by one, ensuring that no cycles are created.

Furthermore, in one embodiment, spanning tree engine 201 uses depth-first search (DFS) or breadth-first search (BFS) to explore the graph of the target quantum architecture and construct a spanning tree by connecting vertices without creating cycles. In one embodiment, the DFS and BFS algorithms traverse the graph of the target quantum architecture by exploring neighbors recursively or iteratively, respectively. In one embodiment, DFS uses a stack while BFS uses a queue. Both algorithms (DFS and BFS) are used to construct a spanning tree by keeping track of the visited vertices and their connections.

In step 902, labeling engine 202 labels the vertices of a Hamiltonian path found in the spanning tree.

As stated above, a Hamiltonian path, as used herein, is a path in a graph that visits every vertex exactly once.

In one embodiment, labeling engine 202 identifies a Hamiltonian path in the spanning tree. In one embodiment, labeling engine 202 starts at any vertex in the spanning tree and follows the edges in a way that visits each vertex only once. In order for such a path to be considered a Hamiltonian path, the path must cover all vertices of the spanning tree, including the starting vertex and the ending vertex. No edge or vertex can be repeated in the path. For example, if the spanning tree has 5 vertices (A, B, C, D, and E), and a Hamiltonian path exists, it could be a path, such as A->B->C->D->E.

Labeling engine 202 utilizes various software tools for identifying a Hamiltonian path in the spanning tree, including, but not limited to, OR-tools, CySpanningTree, etc.

In one embodiment, the labeling of the vertices involves assigning integers to each vertex along the Hamiltonian path, which enables the following of the sequence of the vertices in the Hamiltonian path. As a result, such labeling represents the order of traversal and helps distinguish the Hamiltonian path from other, non-Hamiltonian paths by explicitly showing the order of vertex visitation.

In one embodiment, labeling engine 202 assigns consecutive integers, starting with 1, to each vertex as it is visited in the Hamiltonian path thereby ensuring that each vertex is labeled only once reflecting the Hamiltonian path's property of visiting each vertex exactly once.

As discussed above, a Hamiltonian path is a path in a graph that visits every vertex exactly once. As a result, labeling engine 202 assigns consecutive numbers to the vertices in the order they appear in the path. For example, if spanning tree engine 201 identified a Hamiltonian path as A->B->C->D->E, then labeling engine 202 labels the vertices as follows: A: 1, B: 2, C: 3, D: 4, and E: 5. Such a labeling scheme ensures that each vertex is assigned a unique number, and the numbers reflect the order in which the vertices are visited in the Hamiltonian path.

Labeling engine 202 utilizes various software tools for labeling vertices of a Hamiltonian path found in the spanning tree, including, but not limited to, OR-tools, NetworkX, etc.

In step 903, labeling engine 202 identifies a Hamiltonian path in the graph of the target quantum architecture based on the labeled Hamiltonian path found in the spanning tree.

As discussed above, in one embodiment, the labeled Hamiltonian path in the spanning tree provides a sequence of vertices to follow. Such a sequence of vertices is traced in the graph of the target quantum architecture to find the corresponding Hamiltonian path. For example, suppose that labeling engine 202 identifies a Hamiltonian path in the spanning tree and labels the vertices of such a Hamiltonian path in the spanning tree as discussed above. For instance, labeling engine 202 may label the sequence of Qubit A->Qubit B->Qubit C->Qubit D. Labeling engine 202 then traces the same sequence of qubits (A->B->C->D) on the graph of the target quantum architecture by following the connections that exist in the graph of the target quantum architecture between those qubits thereby identifying the Hamiltonian path in the graph of the target quantum architecture.

Labeling engine 202 utilizes various software tools for identifying a Hamiltonian path in the graph of the target quantum architecture as discussed above, including, but not limited to, OR-tools, CySpanningTree, etc.

In one embodiment, the graph labeling strategy of labeling engine 202 enables the rerouting of the qubits in the graph (H) of the target quantum architecture. In one embodiment, such labeling depends on the quantum architecture (G) to emulate. In one embodiment, the graph of the target quantum architecture corresponds to a d-dimensional grid, where d is a positive integer number, and the emulated quantum architecture corresponds to a cartesian product of the d number of trees.

For instance, suppose that an n-qubit hardware is represented by graph H and provided a quantum circuit C written for a particular quantum architecture (e.g., linear nearest neighbor quantum architecture). In one embodiment, labeling engine 202 assigns each vertex from graph H an integer label such that the order of the labeled vertices provides the path on n vertices that is the linear nearest neighbor quantum architecture. The result is identifying a Hamiltonian path on H. However, not all graphs have a Hamiltonian path as illustrated in FIGS. 3A-3B.

As shown in FIG. 3A, the labeling of the vertices from 1 to 5 illustrates a Hamiltonian path; however, as shown in FIG. 3B, the labeling of the vertices does not result in labeling each of the vertices thereby identifying a non-Hamiltonian graph.

As a result, it is noted that the cube H³, G³, of any connected graph H, G, respectively, has a Hamiltonian path. H^{k}, G^{k} of an undirected graph H, G, respectively, is another graph that has the same set of vertices, but in which two vertices are adjacent when their distance in H, G, respectively, is at most k. H², G², as used herein, is called the square of H, G, respectively. H³, G³, as used herein, is called the cube of H, G, respectively.

In one embodiment, the graph of the target quantum architecture corresponds to a graph that is 2-connected, where the Hamiltonian path is identified by labeling engine 202 in a square of the spanning tree. In another embodiment, the graph of the target quantum architecture corresponds to a graph that is 3-connected, where the Hamiltonian path is identified by labeling engine 202 in a cube of the spanning tree.

As a result, the labeling of H³ results in having each pair of consecutively labeled vertices in H³ at a distance of exactly one while having the vertices of H³ being exactly equal to those of H. Hence, the labeling applied to the vertices of H is such that each pair of consecutively labeled vertices in H is at a distance of at most 3 (distance-3 labeling of H).

Thus, in one embodiment, spanning tree engine 201 identifies a spanning tree T of the hardware graph H (preferably of small maximal degree) and labeling engine 202 labels a Hamiltonian path in H³ and applies this label back to H as illustrated in FIGS. 4A-4B.

As illustrated in FIG. 4A, there is no path in graph 400 that visits every vertex 401 exactly once. However, as illustrated in FIG. 4B, each pair of consecutively labeled vertices 402 in a Hamiltonian path of graph 403 of a spanning tree of graph 400 is at most a distance of 3.

Furthermore, in one embodiment, when H is 2-connected, labeling engine 202 labels the vertices of the Hamiltonian paths in H² (a graph G is 2-connected if for any vertex v of G, G-v is connected).

In one embodiment, the square of a tree, such as the horsetail tree, has a Hamiltonian path. As a result, identifying such a spanning tree on the graph of the target quantum architecture yields a better multiplicative constant on the depth of the transpiled quantum circuit compared to that of the original quantum circuit.

In one embodiment, the labels provided by labeling engine 202 correspond to leapfrogging from one qubit to the next, its neighbor or near-neighbor as illustrated in FIG. 5.

Referring to FIG. 5, the labeling of vertices 501 in a Hamiltonian path 502 (identified by consecutive integer numbers from 0 to 9) of spanning tree 500 is in a leapfrogging manner with a distance-2 labeling (i.e., each pair of consecutively labeled vertices 501 in Hamiltonian path 502 of spanning tree 500 is at most a distance of 2). Such an identified Hamiltonian path 502 is then used to identify a Hamiltonian path in the graph of the target quantum architecture.

In step 904, transpiler 112 transpiles the quantum circuit by arranging an order of the qubits of the quantum circuit based on an order of the qubits from the Hamiltonian path. That is, transpiler 112 rearranges the order of the qubits of the quantum circuit based on the Hamiltonian path found in the graph of the target quantum architecture in order to optimize the quantum circuit's execution on the target quantum device, where the qubits are physically arranged in a particular topology. By rearranging the order of the qubits of the quantum circuit based on the Hamiltonian path found in the graph of the target quantum architecture, a minimal number of SWAP gates may be utilized to map the quantum circuit to the physical device thereby efficiently executing the quantum circuit on the target device. That is, by transpilating the quantum circuit in such a manner, the number of operations (e.g., SWAP gates) is minimized and the circuit's depth (the number of time steps required to execute the quantum circuit) is reduced.

As stated above, in one embodiment, labeling engine 202 performs distance-based labeling of the qubits (vertices of H) so as to provide a direct recipe to group neighboring qubits “on the fly” when parsing the circuit C (originally on hardware G) and rewrite a new circuit C′ with only linearly increased depth. The only places where C′ differs from C is when H differs from G. In such a case, in one embodiment, transpiler 112 implements a gate between two qubits lying at a distance of at most 2 or 3 in H. In one embodiment, transpiler 112 implements the gate by synthesizing a subcircuit (referred to herein as a “box”) implementing the gate on a path of a length of at most 2 or 3 or by inserting SWAP gates (two-qubit operation that exchanges the quantum states of two qubits) as illustrated in FIGS. 6A-6C.

FIG. 6A illustrates an operator 601, O, between qubits q₀ 602A and q₁ 602B. That is, FIG. 6A illustrates operator 601, O, acting on both qubits q₀ 602A and q₁ 602B. Operator 601, as used herein, is a mathematical transformation that acts on the quantum state of qubits. Hence, in one embodiment, operator 601 (e.g., CNOT gate) influences the state of both qubits simultaneously. For example, a CNOT gate acts between the two qubits 602A, 602B, flipping the state of the target qubit based on the state of the control qubit.

Referring now to FIG. 6B, circuit C shown in FIG. 6A is rewritten as C′ as a box 603 by inserting SWAP gates 604 which exchange the quantum states of two qubits, qubits q₀ 602A and q₂ 602C.

Referring now to FIG. 6C, circuit C shown in FIG. 6A is rewritten as C′ as a box 605 by synthesizing a new subcircuit containing operators 601′ (identified as O₁), 601″ (identified as O₂), and 601′″ (identified as O₃), which cross over qubit q₂ 602C.

In one embodiment, two gates that could be executed in parallel on G yield two intersecting boxes, such as boxes 603, 605. Each box will intersect at most O(Δ) other boxes where Δ is the maximum degree of the spanning tree chosen to determine the labeling.

Consequently, it is possible to arrange boxes corresponding to a single layer of the original circuit in a subcircuit of depth at most O(Δ).

In one embodiment, the depth of the content of those boxes depends on the labeling scheme adopted. It is noted that a distance-2 labeling is better than a distance-3 labeling by a small multiplicative constant, but both yield a transpiled circuit of depth O(ΔD), where D is the depth of C.

In one embodiment, the strategy of the present disclosure may be utilized to transpile quantum circuits from a linear nearest neighbor architecture to an arbitrary architecture. Furthermore, the strategy of the present disclosure may be utilized to transpile quantum circuits from the square grid, where the square grid of size n×n is the cartesian product of two paths of size n. A square grid quantum architecture, as used herein, refers to a design where qubits are arranged in a two-dimensional square grid. Thus, when H can be expressed as the cartesian product of two trees T₁ and T₂, the same labeling scheme of the present disclosure can be applied individually on T₁ and T_{2,} which results in providing grid-like coordinates to the vertices of H.

Such a construction can be generalized to a grid of dimension d with H=T₁□T2□ . . . □T_{d}, where □ is the cartesian product of graphs, assigning a size d coordinate vector to each vertex in H. If there is a decomposition of H in the cartesian product of connected graphs G₁□G2□ . . . □Gd of spanning trees T₁, T₂, T_{d}, then labeling engine 202 can label the trees for the same purpose as illustrated in FIGS. 7A-7B.

FIG. 7A illustrates a cartesian product of two trees 701, 702 with a distance-2 labeling.

FIG. 7B illustrates a resulting graph 703 of performing the cartesian product of two trees 701, 702 with a distance-2 labeling shown in FIG. 7A. As illustrated in FIG. 7B, such a resulting graph 703 includes grid-like coordinates.

In one embodiment, applying the strategy of the present disclosure inflates the original circuit depth by a factor of at most O(Δ₁+Δ₂+ . . . +Δ_{d}). Such a result can be generalized to any graph that is a cartesian product of trees of bounded degree.

Furthermore, the principles of the present disclosure enable generalizing known bounds on a line or grid to trees or a cartesian product of trees. For example, CNOT/CZ/Clifford circuits can be synthesized in depth O(n) on a line and thus in depth O(Δn) on a tree of max degree Δ. In another example, permutations can be implemented in depth O(n\hat{ }½) on a grid and thus in depth O(2Δn\hat{ }½) on a cartesian product of trees of max degrees Δ.

In this manner, quantum circuits from a linear nearest neighbor quantum architecture, a square grid quantum architecture or a grid of higher dimension can be transpiled to an arbitrary quantum architecture while preserving the depth of the circuit up to a multiplicative constant.

Furthermore, the principles of the present disclosure improve the technology or technical field involving quantum circuit compilation.

As discussed above, transpilation is a specialized form of compilation that specifically focuses on transforming a quantum circuit to match the constraints and characteristics of a particular target quantum device. It involves decomposing complex gates, such as breaking down complex quantum gates into simpler, native gates supported by the target hardware. Furthermore, transpilation involves optimizing for hardware connectivity, such as rearranging qubits to match the connectivity of the target quantum device, potentially using SWAP gates to overcome limited connectivity. Additionally, transpilation involves optimizing for noise. For example, the impact of noise on the circuit's execution is minimized by optimizing gate placement and timing. Furthermore, transpilation involves Instruction Set Architecture (ISA) compliance, which ensures that the transpiled circuit only uses instructions that are supported by the target quantum device, such as the hardware's available basis gates, measurements, resets, and control flow operations. Transpilation is a crucial step in the broader process of quantum circuit compilation as it ensures that the final quantum circuit is executable on the target quantum hardware and optimized for its specific characteristics. In transpilation, a coupling map, which represents the connectivity of qubits on a quantum device, is crucial for transpilation as it informs the routing and layout stages that determine how virtual qubits are mapped to physical qubits and how gates are implemented. Unfortunately, coupling maps may limit qubit interactions to a strict subset of interactions which negatively affects quantum circuit mapping, which is a key part of transpilation. Quantum circuit mapping is the process of transforming a logical quantum circuit into a physical circuit that can be executed on the target quantum processor. When the coupling map is limited, the mapping process becomes more complex, such as requiring the use of more SWAP gates or other methods to achieve the desired interactions between qubits. As a result, the gate overhead increases which increases the quantum circuit's depth (or execution time). Furthermore, with such limited coupling maps, it becomes difficult to transpile a quantum circuit from one type of quantum architecture (a quantum architecture is a fundamental structure and organization of a quantum computer), such as the linear nearest neighbor architecture, to an arbitrary quantum architecture due to the difficultly in knowing the precise bounds (limits) on the number of gates and the depth of the quantum circuit to be compiled.

Embodiments of the present disclosure improve such technology by identifying a spanning tree of a graph of a target quantum architecture. A spanning tree, as used herein, refers to a subgraph, such as the subgraph of the connected graph of the target quantum architecture, that is a tree without any cycles (closed loops) and includes all the vertices (nodes) of the original graph of the target quantum architecture. The target quantum architecture, as used herein, refers to the specific physical quantum structure and organization or type of qubits that a quantum algorithm is designed to run on. The vertices of a Hamiltonian path found in the spanning tree are then labeled. A Hamiltonian path, as used herein, is a path in a graph that visits every vertex exactly once. In one embodiment, the labeling of the vertices involves assigning integers to each vertex along the Hamiltonian path, which enables the following of the sequence of the vertices in the Hamiltonian path. As a result, such labeling represents the order of traversal and helps distinguish the Hamiltonian path from other, non-Hamiltonian paths by explicitly showing the order of vertex visitation. The Hamiltonian path may then be identified in the graph of the target quantum architecture based on the labeled Hamiltonian path found in the spanning tree. That is, by finding a Hamiltonian path in a spanning tree, which is a simpler graph structure, such information is leveraged to identify a corresponding Hamiltonian path in a more complex graph representing the target quantum architecture. The quantum circuit is then transpiled by arranging an order of qubits of the quantum circuit based on the order of the qubits from the Hamiltonian path. Such a rearrangement of the qubits optimizes the quantum circuit for execution on the target quantum architecture, especially when the qubits have limited connectivity. In this manner, quantum circuits from a linear nearest neighbor quantum architecture, a square grid quantum architecture or a grid of higher dimension can be transpiled to an arbitrary quantum architecture while preserving the depth of the circuit up to a multiplicative constant. Furthermore, in this manner, there is an improvement in the technical field involving quantum circuit compilation.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for performing quantum circuit compilation, the method comprising:
identifying a spanning tree of a graph of a quantum architecture, wherein said spanning tree is a subgraph of said graph of said quantum architecture that connects all vertices of said graph of said quantum architecture without any cycles, wherein said vertices of said spanning tree represent qubits, wherein edges of said spanning tree represent entanglement or interactions between said qubits;
labeling vertices of a Hamiltonian path found in said spanning tree;
identifying a Hamiltonian path in said graph of said quantum architecture based on said labeled Hamiltonian path found in said spanning tree; and
transpiling a quantum circuit by arranging an order of qubits of said quantum circuit based on an order of qubits from said Hamiltonian path identified in said graph of said quantum architecture.

2. The method as recited in claim 1, wherein said labeling depends on a quantum architecture to emulate.

3. The method as recited in claim 2, wherein said graph of said quantum architecture corresponds to a d-dimensional grid, wherein said d is a positive integer number, wherein said emulated quantum architecture corresponds to a cartesian product of said d number of trees.

4. The method as recited in claim 1, wherein said graph of said quantum architecture corresponds to a graph that is 2-connected, wherein said Hamiltonian path is identified in a square of said spanning tree.

5. The method as recited in claim 1, wherein said graph of said quantum architecture corresponds to a graph that is 3-connected, wherein said Hamiltonian path is identified in a cube of said spanning tree.

6. The method as recited in claim 1, wherein said transpilation involves implementing a gate between two qubits lying at a distance of at most two or three in said graph of said quantum architecture.

7. The method as recited in claim 6, wherein said gate is implemented by synthesizing a subcircuit implementing said gate on a path of a length of said at most two or three or by inserting SWAP gates.

8. A computer program product for performing quantum circuit compilation, the computer program product comprising one or more computer readable storage mediums having program code embodied therewith, the program code comprising programming instructions for:
identifying a spanning tree of a graph of a quantum architecture, wherein said spanning tree is a subgraph of said graph of said quantum architecture that connects all vertices of said graph of said quantum architecture without any cycles, wherein said vertices of said spanning tree represent qubits, wherein edges of said spanning tree represent entanglement or interactions between said qubits;
labeling vertices of a Hamiltonian path found in said spanning tree;
identifying a Hamiltonian path in said graph of said quantum architecture based on said labeled Hamiltonian path found in said spanning tree; and
transpiling a quantum circuit by arranging an order of qubits of said quantum circuit based on an order of qubits from said Hamiltonian path identified in said graph of said quantum architecture.

9. The computer program product as recited in claim 8, wherein said labeling depends on a quantum architecture to emulate.

10. The computer program product as recited in claim 9, wherein said graph of said quantum architecture corresponds to a d-dimensional grid, wherein said d is a positive integer number, wherein said emulated quantum architecture corresponds to a cartesian product of said d number of trees.

11. The computer program product as recited in claim 8, wherein said graph of said quantum architecture corresponds to a graph that is 2-connected, wherein said Hamiltonian path is identified in a square of said spanning tree.

12. The computer program product as recited in claim 8, wherein said graph of said quantum architecture corresponds to a graph that is 3-connected, wherein said Hamiltonian path is identified in a cube of said spanning tree.

13. The computer program product as recited in claim 8, wherein said transpilation involves implementing a gate between two qubits lying at a distance of at most two or three in said graph of said quantum architecture.

14. The computer program product as recited in claim 13, wherein said gate is implemented by synthesizing a subcircuit implementing said gate on a path of a length of said at most two or three or by inserting SWAP gates.

15. A system, comprising:
a memory for storing a computer program for performing quantum circuit compilation; and
a processor connected to said memory, wherein said processor is configured to execute program instructions of the computer program comprising:
identifying a spanning tree of a graph of a quantum architecture, wherein said spanning tree is a subgraph of said graph of said quantum architecture that connects all vertices of said graph of said quantum architecture without any cycles, wherein said vertices of said spanning tree represent qubits, wherein edges of said spanning tree represent entanglement or interactions between said qubits;
labeling vertices of a Hamiltonian path found in said spanning tree;
identifying a Hamiltonian path in said graph of said quantum architecture based on said labeled Hamiltonian path found in said spanning tree; and
transpiling a quantum circuit by arranging an order of qubits of said quantum circuit based on an order of qubits from said Hamiltonian path identified in said graph of said quantum architecture.

16. The system as recited in claim 15, wherein said labeling depends on a quantum architecture to emulate.

17. The system as recited in claim 16, wherein said graph of said quantum architecture corresponds to a d-dimensional grid, wherein said d is a positive integer number, wherein said emulated quantum architecture corresponds to a cartesian product of said d number of trees.

18. The system as recited in claim 15, wherein said graph of said quantum architecture corresponds to a graph that is 2-connected, wherein said Hamiltonian path is identified in a square of said spanning tree.

19. The system as recited in claim 15, wherein said graph of said quantum architecture corresponds to a graph that is 3-connected, wherein said Hamiltonian path is identified in a cube of said spanning tree.

20. The system as recited in claim 15, wherein said transpilation involves implementing a gate between two qubits lying at a distance of at most two or three in said graph of said quantum architecture.
